(19) United States
(12) Patent Application Publication
(10) Pub. No.: US 2026/0152240 A1
(43) Pub. Date: Jun. 4, 2026

(54) DEPLOYABLE ROOF RAILS AND METHOD OF OPERATING THE SAME

(71) Applicant: FCA US LLC, Auburn Hills, MI (US)

(72) Inventors: Santiago Antonelli, Auburn Hills, MI (US); Arturo Guzman-Magana, Auburn Hills, MI (US); Prathap Krishnan, Chennai (IN)

(21) Appl. No.: 18/967,088

(22) Filed: Dec. 3, 2024

(51) Int. Cl. B62D 37/02

(52) U.S. Cl. CPC B62D 37/02

(57) ABSTRACT

A method and system for deploying deployable roof rails includes determining a vehicle condition for a vehicle. Based on the vehicle condition, deploying roof rails to extend from a roof of the vehicle, the roof rails being spaced apart and disposed longitudinally relative to the vehicle.

### FIELD

The present disclosure relates to a roof rails for vehicle, and more specifically, to deployable roof rails and a system for deploying the same.

### BACKGROUND

This section provides background information related to the present disclosure which is not necessarily prior art.

The automotive industry currently uses what is commonly known as a rear spoiler, particularly in high performance vehicles like sports cars to increase downforce. The added downforce allows a vehicle to optimize maneuvers such as accelerating, braking, high-speed turning as well as assisting in overall high-speed dynamic stability. However, due to the shape of the vehicle, the performance of the rear spoiler does not reach its full potential.

### SUMMARY

This section provides a general summary of the disclosure, and is not a comprehensive disclosure of its full scope or all of its features.

The present system and method provide a deployable roof rack used to change the airflow around the vehicle.

In one aspect of the disclosure, a method for deploying deployable roof rails includes determining a vehicle condition for a vehicle. Based on the vehicle condition, deploying roof rails to extend from a roof of the vehicle, the roof rails being spaced apart and disposed longitudinally relative to the vehicle.

In another aspect of the disclosure, a system for a vehicle includes deployable roof rails. The roof rails are disposed spaced apart and are disposed longitudinally relative to the vehicle. An actuator is coupled to the deployable roof rails. A controller receives a vehicle condition signal corresponding to a vehicle condition. The controller controls the actuator to deploy the roof rails from a roof of the vehicle.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1A is a perspective view of a vehicle with deployable roof rails deployed.

FIG. 1B is a perspective view of the vehicle of FIG. 1A with the deployable roof rails not deployed.

FIG. 2A is a perspective enlarged view of a roof with the deployable roof rails deployed.

FIG. 2B is an enlarged perspective view of the deployable roof with the roof rails retracted.

FIG. 3A is an enlarged cross-sectional view of a solid roof rail with the roof rail deployed.

FIG. 3B is a cross-sectional view of an inflatable roof rail in the deployed position.

FIG. 3C is a cross-sectional view of the inflatable roof rail of FIG. 3B in a retracted position.

FIG. 4 is block diagrammatic view of a control system for controlling the deployment and retraction of a retractable roof rail.

FIG. 5 is a flowchart of a method for operating the roof rail system.

FIG. 6A is a top view of a vehicle showing downforce intensity without the deployable roof rails deployed.

FIG. 6B is a top view of the vehicle of FIG. 6A showing improved down forces thereon.

Corresponding reference numerals indicate corresponding parts throughout the several views of the drawings.

### DETAILED DESCRIPTION

Example embodiments will now be described more fully with reference to the accompanying drawings.

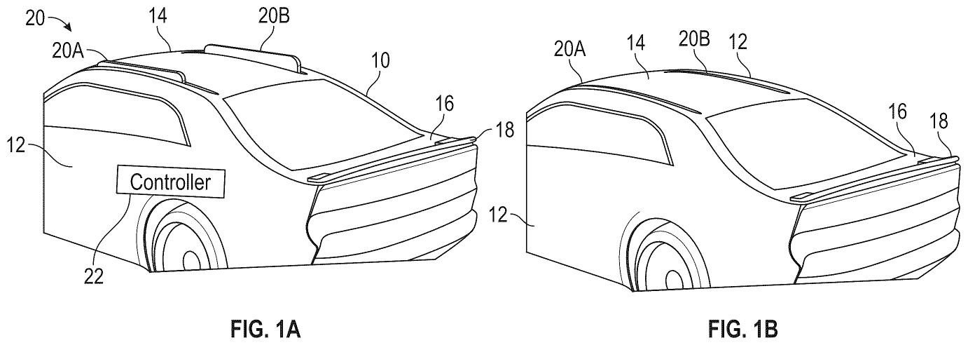

Referring now to FIG. 1A, a partial perspective view of a vehicle 10 is illustrated. The vehicle 10 has a vehicle body 12 having a roof 14. The vehicle 10 also includes a rear door 16 such as a trunk door or hatchback door. The door 16 has an aerodynamic rear spoiler 18 coupled thereto. Typically, spoilers 18 are used in performance vehicles where downforces are priority. However, at certain speeds, spoilers are less effective especially when the spoilers 18 are fixed. Some automakers provide spoilers that move depending upon the speed. However, such devices are typically expensive.

In FIG. 1A, a pair of deployable roof rails 20 are illustrated. Individually, the roof rails 20 are referred to as 20A, 20B. The roof rail 20A is located on the left side or driver's side of the vehicle and roof rail 20B is located on the right side or passenger side (in left hand drive countries). The roof rails 20A, 20B are disposed longitudinally and spaced apart on the vehicle 10. The roof rails 20A, 20B are illustrated in a deployed position and because of their deployed position help direct airflow toward the spoiler 18 of the vehicle to increase the down force provided by the spoiler 18 under certain conditions.

A controller 22 is used to control the pair of roof rails 20 by allowing the roof rails 20A, 20B to be deployed and retracted.

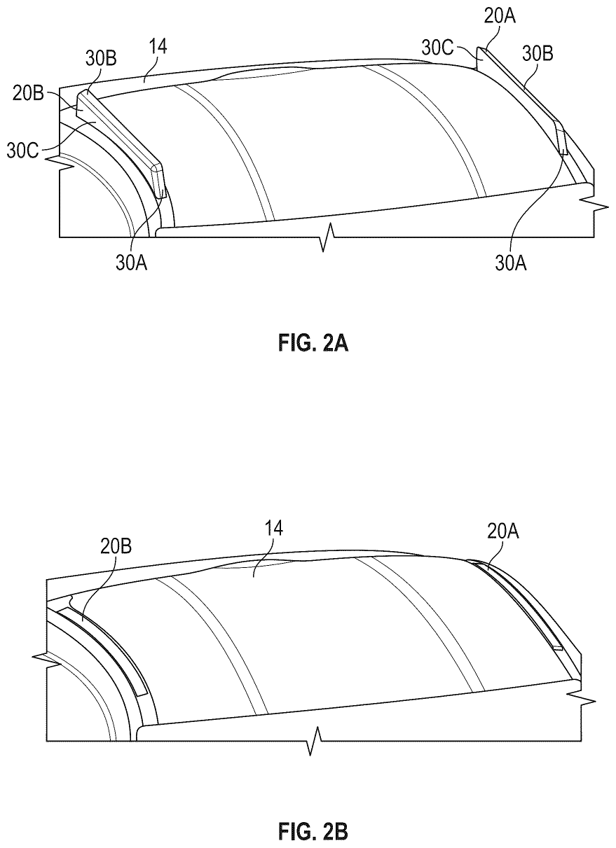

Referring now to FIGS. 2A and 2B, the roof rails 20A and 20B are illustrated in a deployed position in FIG. 2A and a retracted position in FIG. 2B. The roof rails 20, as mentioned above, run longitudinally relative to the vehicle 10. The roof rails 20A, 20B have a front facing surface 30A that is shaped to provide a desired amount of downforce effect. In this example, the surfaces 30A are angled. In the development of the vehicle 10 the angle may be tuned to the desired amount in a wind tunnel or through simulations. An upper surface 30B extends longitudinally relative to the vehicle. Side walls 30C extend vertically from the roof 14.

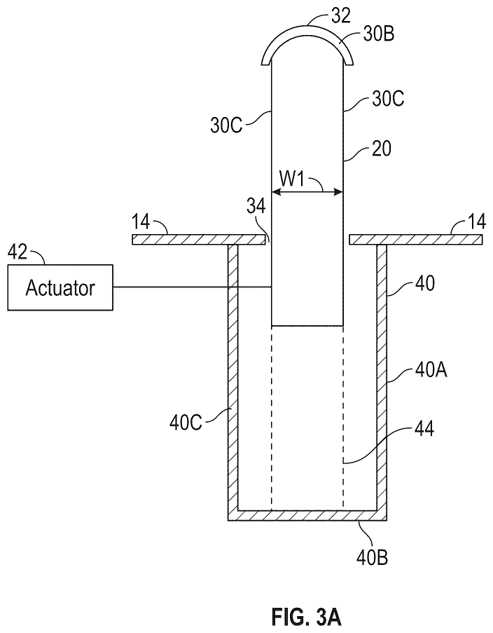

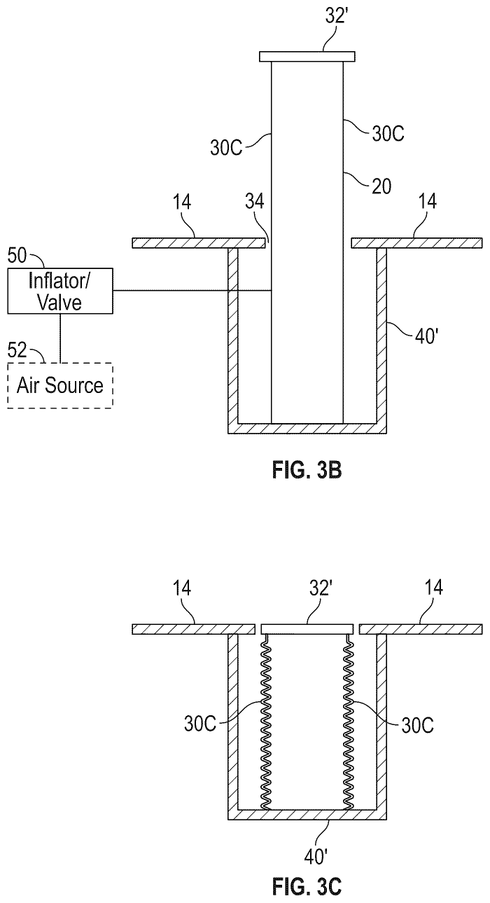

Referring now to FIG. 3A, a solid but deployable roof rail 20 is illustrated. In this example, the reference numeral 20 is used to represent either roof rail 20A or 20B. The roof rail 20 has the vertical side walls 30C as described above. The upper wall 30B of the roof rail 20 has a finished top surface 32 thereon. That is, the top surface 32 may be a finished surface that is aesthetically pleasing. The roof rail 20 extends through an opening 34 of the roof 14. The opening 34 is sized to allow the width W1 of the roof rail 20 to extend and lower. The upper or finished surface 32 may be adjacent to the opening to provide a flush or continuous surface with the roof 14. In this example, the top surface 32 is slightly curved. However, other shapes, such as flat, as described below may be formed according to the desired aesthetic.

The roof 14 may have a pocket 40 that extends vertically downward below the roof 14 for receiving the retracted roof rail 20. The pocket 40 extends longitudinally relative to the vehicle 10. The pocket 40 has a plurality of walls 40A, 40B and 40C that are sized to allow the roof rail 20 to fit therein when not deployed. An actuator 42 is coupled to the roof rail 20. The actuator 42 may be a motor in combination with gears to raise and lower the roof rail 20 relative to the roof 14.

The roof rail 20 may be recessed into the pocket 40 as indicated by the dash lines 44. When recessed, the surface 32 may form a continuous surface with the roof 14. Of course, seals, drains or other types of water build-up prevention may be used in the system.

Referring now to FIGS. 3B and 3C, an example of an inflatable roof rail 20 is illustrated. In this example, the top surface 32′ is a planar surface that is adjacent to the roof 14 when the roof rail 20 is not deployed. In FIG. 3B, the roof rail 20 is deployed so that the walls 30C and 30D are erect and extend above the roof 14. In FIG. 3C, the walls 30C are shown in a compressed form. That is, the roof rail 20 is inflatable and is inflated in FIG. 3B and deflated in FIG. 3C.

An inflator or valve 50 is illustrated as the actuator. The inflator or valve 50 is used for providing air to inflate the roof rail 20 during operation. Should the inflator or valve 50 be a valve, an air source 52 may provide the air from elsewhere within the vehicle 10. An active suspension may provide a source of air that is already provided in the vehicle 10. Therefore, a separate source of air is not required and may reduce the costs. Should no source of air be provided, a separate inflator 50 may be provided for one or both of the roof rails 20 when the roof rails 20 are inflatable. The roof rails 20 illustrated in FIGS. 3B and 3C extend from a pocket 40′ that is not required as deep as the pocket 40 illustrated in FIG. 3A. Because the walls 30C are collapsible, the collapsed walls fit within the pocket 40′ with less depth.

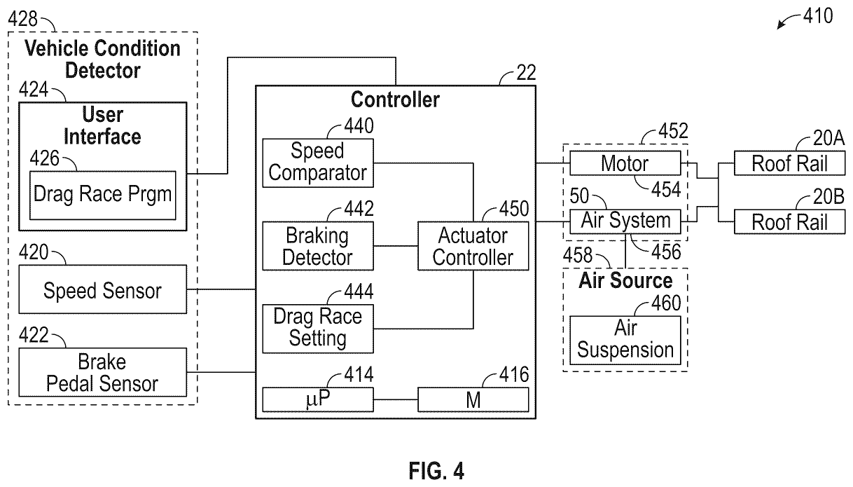

Referring now to FIG. 4, a control system 410 for controlling the deployment of roof rails 20A and 20B is set forth. The controller 22 is illustrated having a microprocessor or processor 414 and a memory 416. The microprocessor or processor 414 is programmed to control the operation of the roof rails into a deployed and retracted position. The memory 416 is a non-transitory, computer-readable medium including machine readable instructions that are executable by the processor 414 for controlling the deployment and retraction of the roof rails. The machine readable instructions allow the processor 414 to be programmed to deploy and retract the deployable roof rails 20A, 20B under predetermined conditions.

The controller 22 is in communication with a vehicle speed sensor 420. The vehicle speed sensor 420 generates a vehicle speed signal that corresponds to the speed of the vehicle 10.

A brake pedal sensor 422 is used for generating a signal that corresponds to the operation of the brake pedal 422. That is, the brake pedal signal from the brake pedal sensor 422 corresponds to the movement of the brake pedal. The speed of the movement of the brake pedal may be determined from the signal. When the movement speed is greater than a predetermined speed, rapid brake operation may be determined. As will be described below, it may be desirable to deploy the roof rails 20A, 20B during braking (rapid or otherwise) and/or speed.

The controller 22 is also in communication with a user interface 424. The user interface 424 may be buttons, dials, a touchscreen or combinations thereof. The user interface may be used for selecting a drag race program 426. In an off-street scenario, the vehicle 10 may race against another vehicle or for a fast time in a drag racing format. As will be described below, it may be desirable to deploy the roof rails 20A, 20B in a drag racing scenario.

The controller 22 has a speed comparator 440. The speed comparator 440 may receive the speed signal from the speed sensor 420 and compare the speed with one or more speed thresholds. In this example, the speed threshold may be a high speed or first threshold. The speed comparator 440 may have a high speed or first threshold therein. The roof rails 20A, 20B may be deployed when a high speed such as a speed greater than 55 mph is achieved. By deploying the roof rails 20A, 20B, the surface 30A and walls 30C help increase the amount of downforce by directing the air moving over the roof 14 toward the spoiler 18 illustrated in FIG. 1.

A braking detector 442 is coupled to the brake pedal sensor 422. In response to the brake pedal signal, the braking detector 442 may be used to deploy the roof rails 20A, 20B. When hard or rapid braking is detected, the roof rails 20A, 20B may be deployed. However, the braking detector 442 may be used in conjunction with the speed comparator 440 for a hard braking scenario above a speed. That is, the braking detector 442 may activate of deploy the roof rails 20A, 20B when the speed is greater than a second threshold. The second threshold may be the same value as the first threshold. However, the second threshold may be lower than the first threshold, such as 45 miles an hour.

A drag race setting 444 may also be provided. The drag race setting 444 receives a signal from the user interface 424 and more specifically from the drag race program 426 that is engaged using the use interface. In response to the drag race setting 444, the roof rails 20A, 20B may be deployed.

A vehicle condition detector 428 for determining a vehicle condition and generating a vehicle condition signal may therefore include one or more of the speed sensor 420, the brake pedal sensor 422 and the user interface 424 with the drag race program 426.

An actuator controller 450 is provided within the controller 22. The actuator controller receives the speed comparison signal from the speed comparator 440, a brake detector signal from the braking detector 442 and a drag race setting from the drag race setting 444. In response to one or more of the signals, the actuator controller 450 deploys one of the actuators 452 for deploying the roof rails 20A, 20B. The actuator controller 450 is also used to retract the roof rails 20A, 20B based upon the speeds, braking or the removal of the drag race setting. That is, when the speed comparator 440 detects the speed is lower than a threshold or the braking detector is not detecting hard or rapid braking, the actuator controller 450 may retract the roof rails 20A and 20B.

The actuator 452 may comprise a motor 454 or an air system 456. As mentioned above, the roof rails 20A, 20B may be a rigid structure that extends from the roof as illustrated in FIG. 3 or an inflatable structure illustrated in FIGS. 3B and 3C. When a rigid structure is used, the actuator 450 may be a motor 454 that is used to raise and lower the roof rails 20A, 20B. The motor 454 may be coupled to a plurality of gears or another type of mechanism for raising and lowering the roof rails 20A, 20B.

The actuator 452 may also be an inflator or valve 50 illustrated in FIG. 3B. The inflator or valve 50 is used to provide air to the inflatable roof rails 20A, 20B. The air system may be an inflator, or a valve as mentioned above. The inflator may be a pump that may be used to deploy the roof rail 20A, 20B within a reasonable of deployment time. The actuator 50 may be coupled to an air source 458. The air source 458 may be an accumulator or another source of air from another device. One example of an air source within a vehicle is an air suspension 460. The air suspension 460 may be an active suspension that uses compressed air to achieve the desired settings for the suspension.

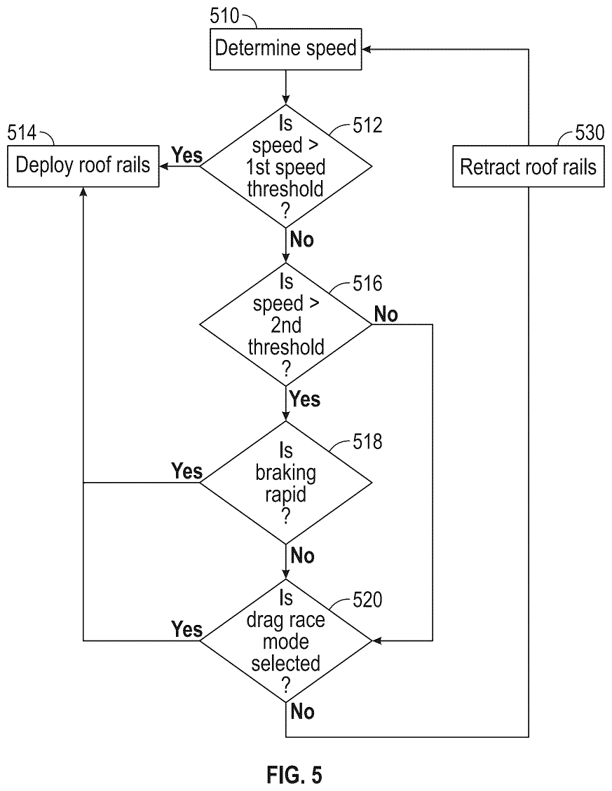

Referring now to FIG. 5, a method for operating the system is set forth. In step 510, the speed of the vehicle is determined. The speed sensor 420 of FIG. 4 may be used to determine the speed of the vehicle. In step 512, if the speed is greater than a first threshold, step 514 deploys the roof rails 20A, 20B if not already deployed. Deploying the roof rails allows the air to be directed to the spoiler. If the speed is not greater than the first speed threshold in step 512, step 516 determines whether the speed is greater than a second threshold. When the speed is greater than a second threshold, but less than the first threshold, step 518 is performed. In step 518, it is determined rapid braking is being performed by the vehicle. Rapid braking may be determined by the brake pedal sensor 422 being deployed or pressed in a rapid manner. Rapid braking also may be determined by the speed sensor determining a deceleration of the vehicle. When the vehicle is braking rapidly, step 514 may be used to deploy the roof rails.

After step 518 and no rapid braking is determined or after step 516 determines the threshold is not greater than a second threshold, step 520 is performed. In step 520, a drag signal may be generated from the drag program 426 illustrated in FIG. 4. When the drag race mode is selected in step 520, step 514 may deploy the roof rail in step 514. In step 520, when the vehicle is not in a drag race mode, the roof rails are retracted in step 530. That is, the roof rails are retracted when they have been deployed when the speed is not greater than a first speed threshold, when the speed is not greater than a second threshold and rapid braking is not performed and when drag racing mode is not selected.

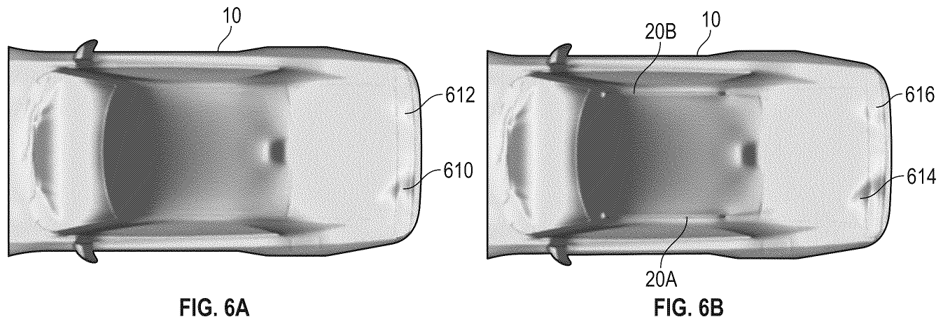

Referring now to FIG. 6A, a top view of the vehicle 10 showing downforce intensity without the deployable roof rails 20A, 20B deployed. Areas 610 and 612 downforces that have an intensity.

Referring now to FIG. 6B, a top view of the vehicle of FIG. 6A showing increased downforces toward the rear of the vehicle when the roof rails 20A, 20B are deployed. Areas 614 and 616 are more intense than areas 610 and 612 respectively. The greater intensity corresponds to more downforce on the rear of the vehicle.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. 1 steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method comprising:
determining a vehicle condition for a vehicle; and
based on the vehicle condition, deploying roof rails to extend from a roof of the vehicle, the roof rails spaced apart and disposed longitudinally relative to the vehicle.

2. The method of claim 1 wherein determining the vehicle condition comprises determining vehicle speed is greater than a first speed threshold.

3. The method of claim 1 wherein determining the vehicle condition comprises determining the vehicle is braking.

4. The method of claim 1 wherein determining the vehicle condition comprises determining a vehicle speed is greater than a speed threshold and the vehicle is braking.

5. The method of claim 1 wherein determining the vehicle condition comprises determining the vehicle is in a drag race mode.

6. The method of claim 1 wherein deploying comprises deploying the roof rails using a motor.

7. The method of claim 1 wherein deploying comprises deploying the roof rails by inflating the roof rails.

8. The method of claim 1 wherein deploying comprises raising a top surface of the roof rail above the roof.

9. The method of claim 1 further comprising directing airflow to a rear spoiler with the roof rails.

10. The method of claim 1 further comprising retracting the roof rails after retracting the roof rails.

11. The method of claim 1 further comprising retracting the roof rails in response to the vehicle condition.

12. The method of claim 1 further comprising retracting the roof rails in response to the vehicle condition so that a top surface of the roof rail is adjacent to an opening in the roof.

13. The method of claim 1 further comprising retracting the roof rails into a pocket below the roof in response to the vehicle condition.

14. A system for a vehicle comprising:
deployable roof rails disposed spaced apart and disposed longitudinally relative to the vehicle;
an actuator coupled to the deployable roof rails;
a controller receiving a vehicle condition signal corresponding to a vehicle condition; and
said controller controlling the actuator to deploy the roof rails from a roof of the vehicle.

15. The system of claim 14 wherein the vehicle condition comprises a vehicle speed greater than a first speed threshold.

16. The system of claim 14 wherein the vehicle condition comprises the vehicle is braking.

17. The system of claim 14 wherein the vehicle condition comprises the vehicle being in a drag race mode.

18. The system of claim 14 wherein the actuator comprises a motor or inflator.

19. The system of claim 14 wherein the roof comprises a pocket and wherein the controller controls the actuator to retract the roof rails into the pocket in response to the vehicle condition.

20. The system of claim 14 wherein the deployable roof rails comprise a top surface and wherein the controller controls the actuator to retract the roof rails, so the top surface is adjacent an opening in the roof.
